(19) United States
(12) Patent Application Publication
(10) Pub. No.: US 2009/0226186 A1
(43) Pub. Date: Sep. 10, 2009

(54) OPTICAL PHASE-SHIFT-KEYING DEMODULATOR BIAS CONTROL METHOD

(76) Inventors: Jose E. ROMAN, Catonsville, MD (US); William J. Ulrich, Baltimore, MD (US); Shan Zhong, Ellicott City, MD (US)

Correspondence Address: Clements Bernard PLLC, 1901 Roxborough Road, Suite 300, Charlotte, NC, 28211, US

(21) Appl. No.: 12/042,748

(22) Filed: Mar. 5, 2008

(51) Int. Cl. H04B 10/06

(52) U.S. Cl. 398/202

(57) ABSTRACT

The present invention provides a method for biasing/controlling an optical demodulator suitable for use in an optical phase-shift-keying (PSK) system, such as an optical differential-phase-shift-keying (DPSK) system or an optical differential-quadrature-phase-shift-keying (DQPSK) system, the method including: receiving a signal from an optical demodulator/balanced receiver pair; full-wave rectifying the signal; passing the full-wave rectified signal through a low-pass filter; monitoring the full-wave rectified signal received from the optical demodulator/balanced receiver pair and passed through the low-pass filter; and providing related feedback to the optical demodulator. Preferably, the signal includes a radio frequency (RF) signal. Full-wave rectifying the signal includes full-wave rectifying the signal using a full-wave rectifying circuit. Optionally, the low-pass filter includes about a 1 GHz bandwidth (BW) low-pass filter. Monitoring the full-wave rectified signal received from the optical demodulator/balanced receiver pair and passed through the low-pass filter includes monitoring the full-wave rectified signal using an RF power meter. The RF signal power monitored is dependent on an optical phase shift of the optical demodulator. Optionally, the method is employed in a high data rate optical transmission system.

### FIELD OF THE INVENTION

The present invention relates generally to a method for biasing/controlling an optical demodulator suitable for use in an optical phase-shift-keying (PSK) system, such as an optical differential-phase-shift-keying (DPSK) system or an optical differential-quadrature-phase-shift-keying (DQPSK) system. This method is particularly applicable to high data rate (e.g. 40 Gb/s (40 G) and 100 Gb/s (100 G)) optical transmission systems.

### BACKGROUND OF THE INVENTION

In optical transmission systems employing phase-shift-keying (PSK) formats, electrical digital 1's and 0's at the transmitter end are encoded into 0 and π phase shifts on the optical signal. At the receiver end, an optical demodulator acts as a digital decoder. When used with a balanced receiver pair, the optical demodulator converts the 0 and π phase shifts on the optical signal into electrical digital 1's and 0's.

Referring to FIG. 1, the optical demodulator 10 coupled to the balanced receiver pair 12 is an assymetric delay line interferometer with a fixed delay, T, and an adjustable optical phase shift, φₒ. In order to properly decode phase transitions 14, the optical phase shift, φₒ, must be tuned or biased to an optimum point. For example, in an optical differential-quadrature-phase-shift-keying (DQPSK) system, the optical phase shift, φₒ, must be set to +π/4 or −π/4. For the system to work properly, it is necessary to maintain the optical phase shift, φₒ, at its optimum point over all operating conditions, as this optimum point may drift over time due to thermal changes or frequency drifts in the optical source. Furthermore, a DQPSK system requires two optical demodulators 10, and each optical demodulator 10 must be maintained at its optimum point. Thus, implementing a robust scheme for optical demodulator bias control is critical in maintaining optimum PSK system performance.

There are several conventional techniques for optical demodulator bias control, each of which has significant shortcomings.

Carrier leak through detection: Generally, PSK signals do not have a direct current (DC) frequency component (i.e. the time average is zero). A carrier signal may be generated by modulating the bias voltage at the transmitter. At the receiver end, this carrier signal leaks into the photodetector at the optical demodulator output. The strength of this carrier signal leak may be used as feedback to control the demodulator bias. This methodology is described in IEEE Photonics Technology Letters, Vol. 6, February 1994, pp. 263-265. The shortcoming of this methodology, however, is that it is tied to another component in the transceiver, namely, the modulator bias. If the modulator bias drifts, then the demodulator bias will drift.

Bit error rate (BER)/forward error correction (FEC) monitoring: There are several variations of this methodology, wherein the demodulator phase shift is tuned to minimize the BER of the FEC decoder. For example, the phase shift of each demodulator on the DQPSK receiver may be simultaneously tuned to minimize the BER of the FEC decoder. The methodology is described in U.S. Patent Application Publication No. 2007/0177151, U.S. Patent Application Publication No. 2007/0065157, and U.S. Patent Application Publication No. 2006/0067703.

One shortcoming of this methodology, however, is that, for a DQPSK system (requiring two demodulators), it requires the simultaneous tuning of both demodulators, thus complicating the control scheme. For example, if only one of the demodulators is off of its bias point, it is not readily apparent which of the two demodulators should be optimized in order to reduce the BER. Another shortcoming of this methodology is that it ties the BER signal to the control of the demodulator, thus making it more difficult to use the BER signal for the control of other components, such as a tunable dispersion compensator (TDC), etc.

Radio frequency (RF) signal detection: In this methodology, described in U.S. Patent Application Publication No. 2007/0047964, the RF output from the balanced receiver pair is tapped into a squaring circuit and filtered. The filtered RF output power is dependent on the optical phase shift, φₒ, of the demodulator (i.e. the delay interferometer), and this dependence may be used to maintain the optical phase shift, φₒ, of the demodulator at its optimum point. Each demodulator may be biased independently, control is local to each demodulator, and the BER signal is free for the control of other components, such as a TDC, etc. The shortcoming of this methodology, however, is that employing a squaring circuit is a non-linear process and requires relatively high RF signal powers. This leads to increased complexity and cost of the control circuit.

Thus, what is still needed in the art is a method for biasing/controlling an optical demodulator suitable for use in an optical PSK system, such as an optical DPSK system or an optical DQPSK system that overcomes the shortcomings described above. Preferably, this method is particularly applicable to high data rate (e.g. 40 G and 100 G) optical transmission systems.

### BRIEF SUMMARY OF THE INVENTION

In one exemplary embodiment, the present invention provides a method for biasing/controlling an optical demodulator suitable for use in an optical phase-shift-keying (PSK) system, such as an optical differential-phase-shift-keying (DPSK) system or an optical differential-quadrature-phase-shift-keying (DQPSK) system, the method including: receiving a signal from an optical demodulator/balanced receiver pair; full-wave rectifying the signal received from the optical demodulator/balanced receiver pair; passing the full-wave rectified signal received from the optical demodulator/balanced receiver pair through a low-pass filter; monitoring the full-wave rectified signal received from the optical demodulator/balanced receiver pair and passed through the low-pass filter; and providing related feedback to the optical demodulator. Preferably, the signal received from the optical demodulator/balanced receiver pair includes a radio frequency (RF) signal. Full-wave rectifying the signal received from the optical demodulator/balanced receiver pair includes full-wave rectifying the signal received from the optical demodulator/balanced receiver pair using a full-wave rectifying circuit. Optionally, the low-pass filter includes about a 1 GHz bandwidth (BW) low-pass filter. Monitoring the full-wave rectified signal received from the optical demodulator/balanced receiver pair and passed through the low-pass filter includes monitoring the full-wave rectified signal received from the optical demodulator/balanced receiver pair and passed through the low-pass filter using an RF power meter. The RF signal power monitored by the RF power meter is dependent on an optical phase shift of the optical demodulator. Optionally, the method is employed in a high data rate optical transmission system.

In another exemplary embodiment, the present invention provides a system for biasing/controlling an optical demodulator suitable for use in an optical phase-shift-keying (PSK) system, such as an optical differential-phase-shift-keying (DPSK) system or an optical differential-quadrature-phase-shift-keying (DQPSK) system, the system including: an optical demodulator/balanced receiver pair operable for outputting a signal; a full-wave rectifying circuit operable for receiving and full-wave rectifying the signal outputted by the optical demodulator/balanced receiver pair; a low-pass-filter operable for receiving and selectively passing the full-wave rectified signal outputted by the full-wave rectifying circuit; a power meter operable for monitoring the full-wave rectified signal selectively passed by the low-pass filter; and a feedback loop operable for providing related feedback to the optical demodulator. Preferably, the signal outputted by the optical demodulator/balanced receiver pair includes a radio frequency (RF) signal. Optionally, the low-pass filter includes about a 1 GHz bandwidth (BW) low-pass filter. Preferably, the power meter includes an RF power meter. The RF signal power monitored by the RF power meter is dependent on an optical phase shift of the optical demodulator. Optionally, the system is employed in a high data rate optical transmission system.

In a further exemplary embodiment, the present invention provides a method for biasing/controlling an optical demodulator suitable for use in an optical phase-shift-keying (PSK) system, such as an optical differential-phase-shift-keying (DPSK) system or an optical differential-quadrature-phase-shift-keying (DQPSK) system, the method including: receiving a signal from an optical demodulator/balanced receiver pair; and providing feedback to the optical demodulator, wherein the feedback corresponds to a signal power of the signal after the signal is full-wave rectified and low-pass filtered. Preferably, the signal received from the optical demodulator/balanced receiver pair includes a radio frequency (RF) signal. Preferably, the signal power of the signal after the signal is full-wave rectified and low-pass filtered includes the RF signal power of the signal after the signal is full-wave rectified and low-pass filtered. Optionally, the method is employed in a high data rate optical transmission system.

### BRIEF DESCRIPTION OF THE DRAWINGS

The present invention is illustrated and described herein with reference to the various drawings, in which like reference numbers are used to denote like system components/method steps, as appropriate, and in which:

FIG. 1 is a schematic diagram illustrating an optical demodulator coupled to a balanced receiver pair, wherein the optical demodulator is an assymetric delay line interferometer with a fixed delay, T, and an adjustable optical phase shift, φₒ;

FIG. 2 is a schematic diagram illustrating, in one exemplary embodiment of the present invention, a method for biasing/controlling an optical demodulator that is based on the signal processing of a radio frequency (RF) signal from the demodulator/balanced receiver pair, wherein the signal, v(t), from each demodulator/balanced receiver pair is full-wave rectified into |v(t)| and passed through a low-pass filter;

FIG. 3 is a schematic diagram and a series of plots illustrating the principle of full-wave rectification as used in FIG. 2;

FIG. 4 is a plot of the relative power of the electrical signal (40 MHz-1 GHz) (dB) as a function of the optical phase (degrees);

FIG. 5 is a plot of the relative power of the electrical signal (40 MHz-1 GHz) (dB) as a function of the optical power imbalance between the demodulator outputs (dB);

FIG. 6 is a plot of the relative power of the electrical signal (40 MHz-1 GHz) (dB) as a function of the optical delay mismatch between the demodulator outputs (bits); and

FIG. 7 is a schematic diagram illustrating, in one exemplary embodiment of the present invention, an experimental setup for demonstrating the method of FIG. 2.

### DETAILED DESCRIPTION OF THE INVENTION

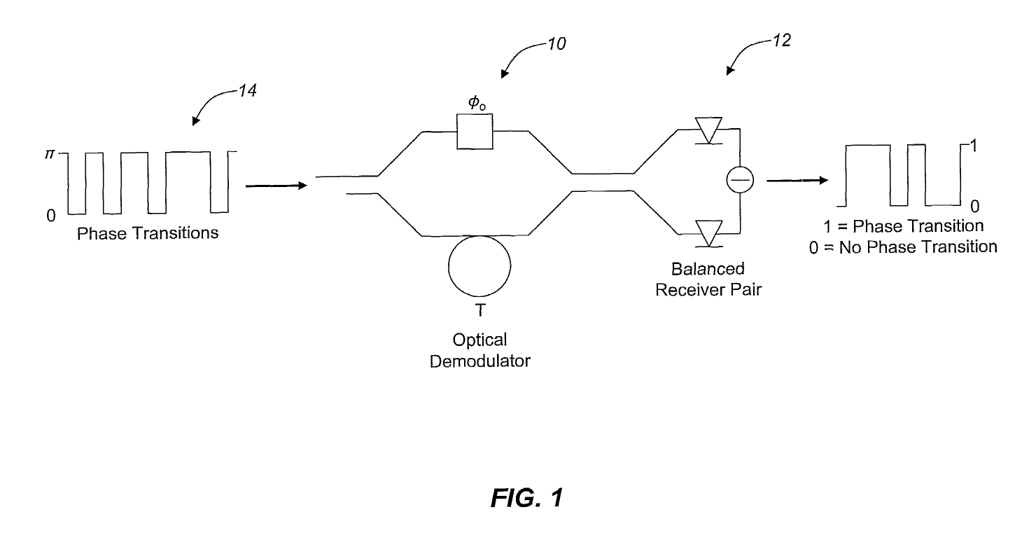

Referring again to FIG. 1, the optical demodulator 10 coupled to the balanced receiver pair 12 is an assymetric delay line interferometer with a fixed delay, T, and an adjustable optical phase shift, φₒ. In order to properly decode phase transitions 14, the optical phase shift, φₒ, must be tuned or biased to an optimum point. For example, in an optical differential-quadrature-phase-shift-keying (DQPSK) system, the optical phase shift, φₒ, must be set to +π/4 or −π/4. For the system to work properly, it is necessary to maintain the optical phase shift, φₒ, at its optimum point over all operating conditions, as this optimum point may drift over time due to thermal changes or frequency drifts in the optical source. This may be accomplished via a feedback loop of some sort. Furthermore, a DQPSK system requires two optical demodulators 10, and each optical demodulator 10 must be maintained at its optimum point. Thus, implementing a robust scheme for optical demodulator bias control is critical in maintaining optimum phase-shift-keying (PSK) system performance.

Again, there are several conventional techniques for optical demodulator bias control, each of which has significant shortcomings.

Carrier leak through detection: As described above, generally, PSK signals do not have a direct current (DC) frequency component (i.e. the time average is zero). A carrier signal may be generated by modulating the bias voltage at the transmitter. At the receiver end, this carrier signal leaks into the photodetector at the optical demodulator output. The strength of this carrier signal leak may be used as feedback to control the demodulator bias. This methodology is described in IEEE Photonics Technology Letters, Vol. 6, February 1994, pp. 263-265. The shortcoming of this methodology, however, is that it is tied to another component in the transceiver, namely, the modulator bias. If the modulator bias drifts, then the demodulator bias will drift.

Bit error rate (BER)/forward error correction (FEC) monitoring: As also described above, there are several variations of this methodology, wherein the demodulator phase shift is tuned to minimize the BER of the FEC decoder. For example, the phase shift of each demodulator on the DQPSK receiver may be simultaneously tuned to minimize the BER of the FEC decoder. The methodology is described in U.S. Patent Application Publication No. 2007/0177151, U.S. Patent Application Publication No. 2007/0065157, and U.S. Patent Application Publication No. 2006/0067703.

One shortcoming of this methodology, however, is that, for a DQPSK system (requiring two demodulators), it requires the simultaneous tuning of both demodulators, thus complicating the control scheme. For example, if only one of the demodulators is off of its bias point, it is not readily apparent which of the two demodulators should be optimized in order to reduce the BER. Another shortcoming of this methodology is that it ties the BER signal to the control of the demodulator, thus making it more difficult to use the BER signal for the control of other components, such as a tunable dispersion compensator (TDC), etc.

Radio frequency (RF) signal detection: As further described above, in this methodology, described in U.S. Patent Application Publication No. 2007/0047964, the RF output from the balanced receiver pair is tapped into a squaring circuit and filtered. The filtered RF output power is dependent on the optical phase shift, φₒ, of the demodulator (i.e. the delay interferometer), and this dependence may be used to maintain the optical phase shift, φₒ, of the demodulator at its optimum point. Each demodulator may be biased independently, control is local to each demodulator, and the BER signal is free for the control of other components, such as a TDC, etc. The shortcoming of this methodology, however, is that employing a squaring circuit is a non-linear process and requires relatively high RF signal powers. This leads to increased complexity and cost of the control circuit.

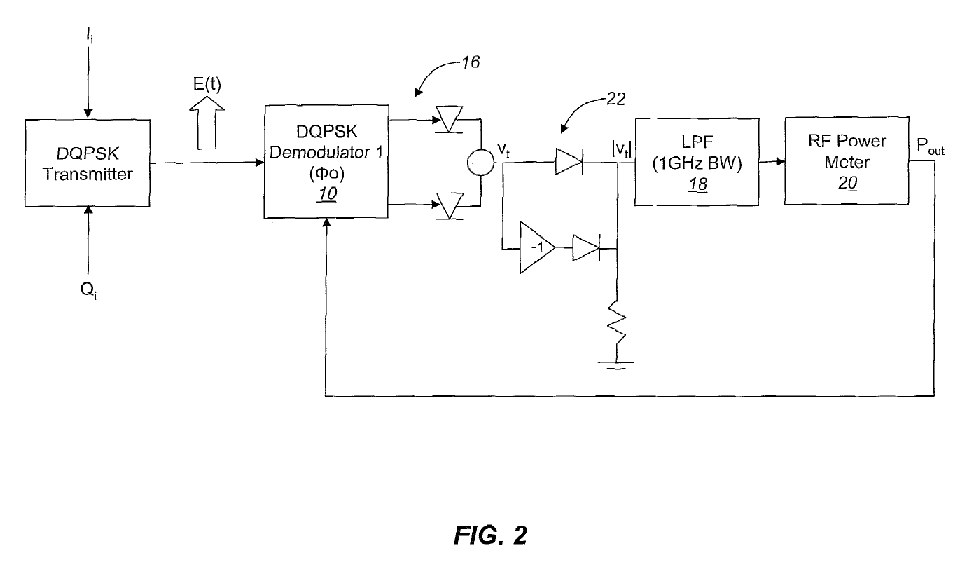

Referring to FIG. 2, in one exemplary embodiment, the present invention provides a method for biasing/controlling an optical demodulator 10 suitable for use in an optical PSK system, such as an optical DPSK system or an optical DQPSK system. This method is particularly applicable to high data rate (e.g. 40 Gb/s (40 G) and 100 Gb/s (100 G)) optical transmission systems. The method is based on the signal processing of a radio frequency (RF) signal from the demodulator/balanced receiver pair 16. However, instead of using a squaring circuit, the signal, v(t), from each demodulator/balanced receiver pair 16 is full-wave rectified into |v(t)| and passed through a low-pass filter 18 (e.g. a 1 GHz bandwidth (BW) low-pass filter). The RF signal power from the low-pass filter 18 is dependent on the optical phase shift, φₒ, of the demodulator 10, and is monitored by an RF power meter 20. In this manner, feedback is provided to the demodulator 10. In FIG. 2,

E(t)=1/√2(X(t)+jY(t));

V(t)=½{ cos(φₒ)(X(t)X(t−T)+Y(t)Y(t−T))+sin (φₒ)(Y(t)X(t−T)−X(t)Y(t−T))}; and

|v(t)|=√(⅛(X²(t)+Y²(t))(X²(t−T)+Y²(t−T))+½ cos(2φₒ)X(t)Y(t)X(t−T)Y(t−T)).

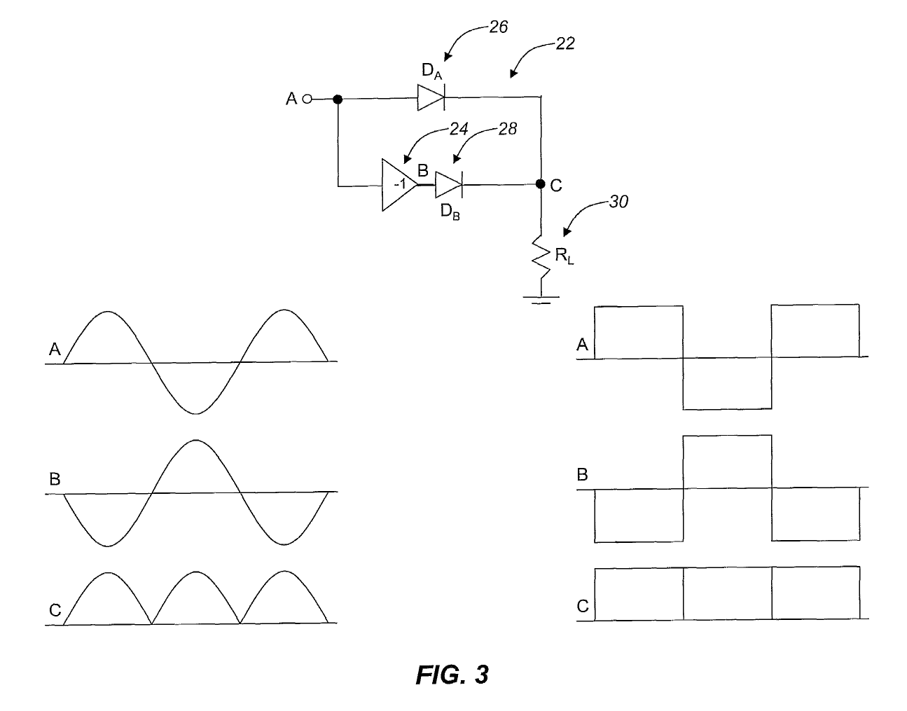

Referring to FIG. 3, the full-wave rectifying circuit 22 includes in inverting amplifier 24, a pair of diodes, D_{A} 26 and D_{B} 28, and a resistor, R_{L} 30, for example. At B, the input from A is inverted by the inverting amplifier 24. At C, full-wave rectification is completed by the pair of diodes, D_{A} 26 and D_{B} 28.

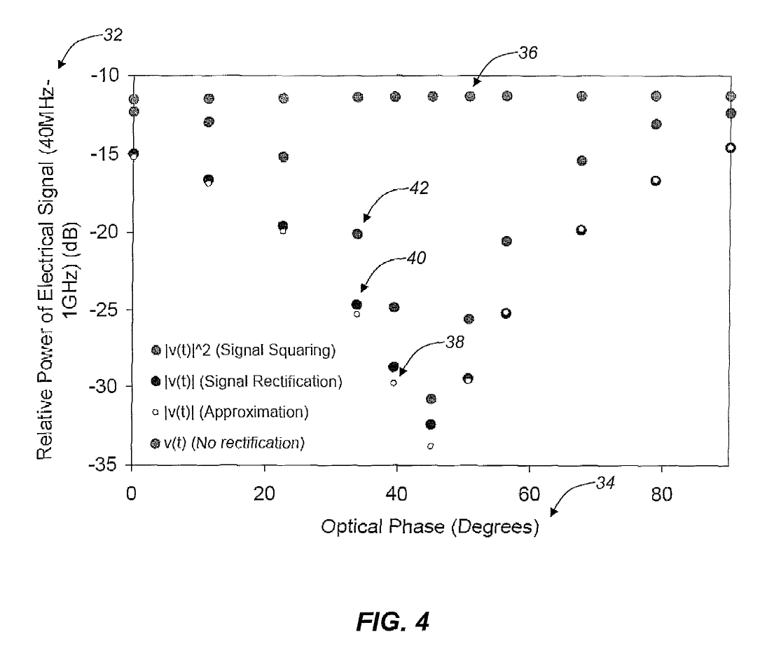

For DQPSK, in particular, it may be demonstrated that when the optical phase shift of the demodulator 10 (FIGS. 1 and 2) is at its optimum point (±π/4, for example), the RF power of the low-pass filter 18 (FIG. 2) as measured at the RF power meter 20 (FIG. 2) is minimized (i.e. the waveform distortion is minimized). It may also be demonstrated that this bias control technique works only if the signal is rectified or squared, which is not an obvious effect. Without rectification, the signal RF output power does not depend on the phase shift of the demodulator 10. FIG. 4 is a plot of the relative power of the electrical signal (40 MHz-1 GHz) (dB) 32 as a function of the optical phase (degrees) 34 for v(t) with no rectification 36, an approximation of |v(t)| 38, |v(t)| with signal rectification 40, and |v(t)| with signal squaring 42.

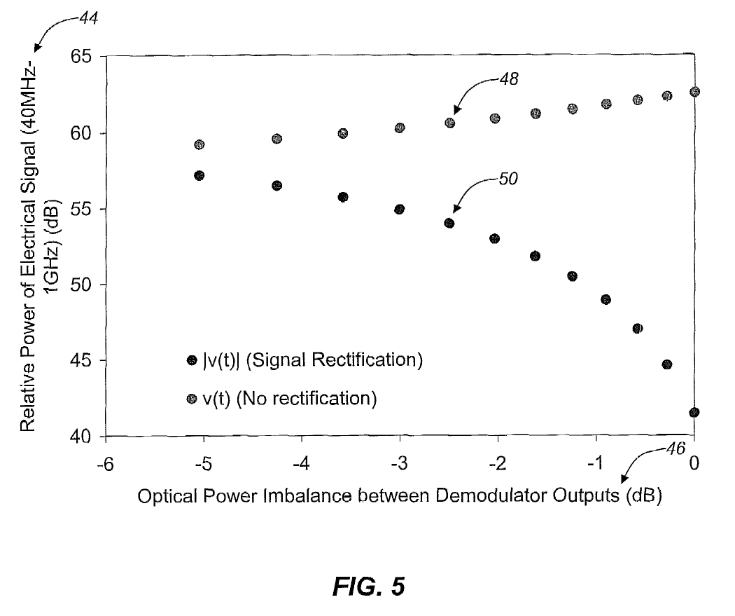

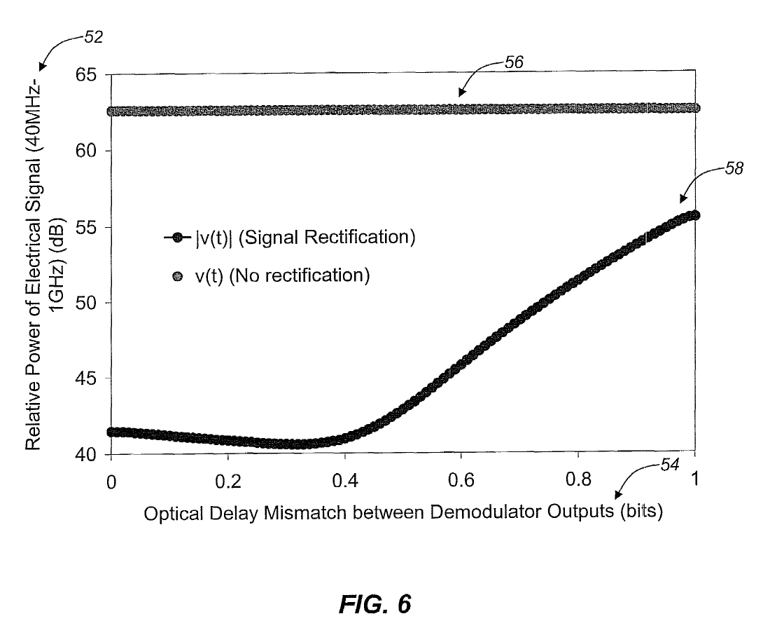

The detection circuit of the present invention may be used to verify or monitor the optical delay and power mismatch between the demodulator outputs. FIG. 5 is a plot of the relative power of the electrical signal (40 MHz-1 GHz) (dB) 44 as a function of the optical power imbalance between the demodulator outputs (dB) 46 for v(t) with no rectification 48 and |v(t)| with signal rectification 50. FIG. 6 is a plot of the relative power of the electrical signal (40 MHz-1 GHz) (dB) 52 as a function of the optical delay mismatch between the demodulator outputs (bits) 54 for v(t) with no rectification 56 and |v(t)| with signal rectification 58.

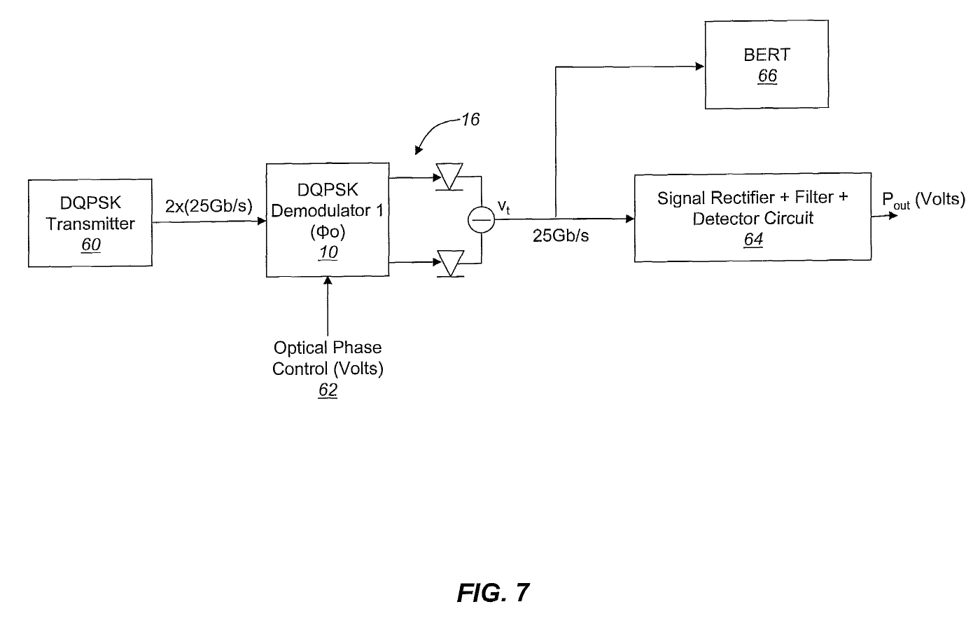

Referring to FIG. 7, the bias control technique of the present invention may be demonstrated using an experimental setup including a DQPSK transmitter 60 that carries two signals that are 90 degrees out of phase, each operating at a baud rate of 24.946 Gb/s for a bit rate of 49.892 Gb/s. At the receiver end, a single demodulator 10 is used to decode a single signal at 24.946 Gb/s. The demodulator has a delay, T, of 45.5 ps and its optical phase shift, φₒ, may be tuned/adjusted by applying a 0-5 VDC optical phase control signal 62. Signal rectification/filtering is implemented using a 10 GHz log detector followed by a 500 MHz log amplifier (collectively 64) having a slope of 20 mV/dB. The electrical output of the demodulator/balanced receiver pair 16 is fed to the error analyzer of a bit error rate tester (BERT) 66. Thus, both the RF output power (Pₒᵤₜ (Volts)) and the BER may be measured as the voltage controlling the optical phase shift, φₒ, of the demodulator 10 is adjusted.

It is observed that the optimum demodulator bias point (i.e. the lowest BER) coincides with the minimum RF power out of the rectifier/filter circuit 64. The eye patterns captured on a scope demonstrate maximum eye opening when the RF signal is minimized. The bias control technique of the present invention is also proven to work even at low optical signal-to-noise ratios (OSNRs).

Thus, the bias control technique of the present invention is simple and cheap, as signal rectification is simpler and cheaper than signal squaring. It provides for independent local control of each demodulator (i.e. it is not tied to the transmitter or to the BER signal from the FEC). Finally, the BER signal is freed as feedback for some other control, such as a TDC, etc.

Although the present invention has been illustrated and described herein with reference to preferred embodiments and specific examples thereof, it will be readily apparent to those of ordinary skill in the art that other embodiments and/or examples can perform similar functions and/or achieve like results. All such equivalent embodiments and/or examples are within the spirit and scope of the present invention, are contemplated thereby, and are intended to be covered by the following claims.

What is claimed is:

1. A method for biasing/controlling an optical demodulator suitable for use in an optical phase-shift-keying (PSK) system, such as an optical differential-phase-shift-keying (DPSK) system or an optical differential-quadrature-phase-shift-keying (DQPSK) system, the method comprising:
receiving a signal from an optical demodulator/balanced receiver pair;
full-wave rectifying the signal received from the optical demodulator/balanced receiver pair;
passing the full-wave rectified signal received from the optical demodulator/balanced receiver pair through a low-pass filter;
monitoring the full-wave rectified signal received from the optical demodulator/balanced receiver pair and passed through the low-pass filter; and
providing related feedback to the optical demodulator.

2. The method of claim 1, wherein the signal received from the optical demodulator/balanced receiver pair comprises a radio frequency (RF) signal.

3. The method of claim 1, wherein full-wave rectifying the signal received from the optical demodulator/balanced receiver pair comprises full-wave rectifying the signal received from the optical demodulator/balanced receiver pair using a full-wave rectifying circuit.

4. The method of claim 1, wherein the low-pass filter comprises about a 1 GHz bandwidth (BW) low-pass filter.

5. The method of claim 1, wherein monitoring the full-wave rectified signal received from the optical demodulator/balanced receiver pair and passed through the low-pass filter comprises monitoring the full-wave rectified signal received from the optical demodulator/balanced receiver pair and passed through the low-pass filter using an RF power meter.

6. The method of claim 5, wherein an RF signal power monitored by the RF power meter is dependent on an optical phase shift of the optical demodulator.

7. The method of claim 1, wherein the method is employed in a high data rate optical transmission system.

8. A system for biasing/controlling an optical demodulator suitable for use in an optical phase-shift-keying (PSK) system, such as an optical differential-phase-shift-keying (DPSK) system or an optical differential-quadrature-phase-shift-keying (DQPSK) system, the system comprising:
an optical demodulator/balanced receiver pair operable for outputting a signal;
a full-wave rectifying circuit operable for receiving and full-wave rectifying the signal outputted by the optical demodulator/balanced receiver pair;
a low-pass-filter operable for receiving and selectively passing the full-wave rectified signal outputted by the full-wave rectifying circuit;
a power meter operable for monitoring the full-wave rectified signal selectively passed by the low-pass filter; and
a feedback loop operable for providing related feedback to the optical demodulator.

9. The system of claim 8, wherein the signal outputted by the optical demodulator/balanced receiver pair comprises a radio frequency (RF) signal.

10. The system of claim 8, wherein the low-pass filter comprises about a 1 GHz bandwidth (BW) low-pass filter.

11. The system of claim 8, wherein the power meter comprises an RF power meter.

12. The system of claim 11, wherein an RF signal power monitored by the RF power meter is dependent on an optical phase shift of the optical demodulator.

13. The system of claim 8, wherein the system is employed in a high data rate optical transmission system.

14. A method for biasing/controlling an optical demodulator suitable for use in an optical phase-shift-keying (PSK) system, such as an optical differential-phase-shift-keying (DPSK) system or an optical differential-quadrature-phase-shift-keying (DQPSK) system, the method comprising:
receiving a signal from an optical demodulator/balanced receiver pair; and
providing feedback to the optical demodulator, wherein the feedback corresponds to a signal power of the signal after the signal is full-wave rectified and low-pass filtered.

15. The method of claim 14, wherein the signal received from the optical demodulator/balanced receiver pair comprises a radio frequency (RF) signal.

16. The method of claim 15, wherein the signal power of the signal after the signal is full-wave rectified and low-pass filtered comprises the RF signal power of the signal after the signal is full-wave rectified and low-pass filtered.

17. The method of claim 14, wherein the method is employed in a high data rate optical transmission system.
